(19) United States
(12) Patent Application Publication
(10) Pub. No.: US 2026/0346776 A1
(43) Pub. Date: Nov. 5, 2026

(54) PORT TUBE AND DEVICES USING SAME

(71) Applicant: Stellar Industries, Inc., Garner, IA (US)

(72) Inventor: Mitchell Paul Horstman, Garner, IA (US)

(21) Appl. No.: 19/667,220

(22) Filed: May 4, 2026

Related U.S. Application Data
(60) Provisional application No. 63/798,991, filed on May 2, 2025.

(51) Int. Cl. B60P 1/16; B65F 3/26

(52) U.S. Cl. CPC B60P 1/162; B65F 3/26

(57) ABSTRACT

Disclosed are telescoping port tubes and systems using the same for transferring pressurized fluid between components that move relative to one another. A telescoping port tube includes a first conduit and a second conduit telescopingly arranged with respect to one another to define a fluid flow path having a length that varies as the conduits extend and retract. The telescoping port tube may be connected between portions of a hydraulic system such that the telescoping port tube extends and retracts in response to movement of a hydraulic cylinder while maintaining fluid communication. In example embodiments, one or more telescoping port tubes are used in a hooklift truck to transfer hydraulic fluid between hydraulic cylinders arranged within a jib assembly, thereby reducing hose fatigue, minimizing space requirements, and improving durability.

### CROSS REFERENCE TO RELATED APPLICATIONS

This application claims the benefit of U.S. Provisional Patent Application No. 63/798.991 which was filed with the United States Patent and Trademark Office on May 2, 2025, the entire contents of which are herein incorporated by reference.

### BACKGROUND

### 1. Field

Example embodiments relate to telescoping port tubes and various devices using the same.

### 2. Description of the Related Art

Hooklift trucks are commonly used in the refuse industry to grab and haul refuse containers. As one skilled in the art will appreciate, hooklift trucks generally include an L-shaped jib and a hook telescopingly supported in the jib. The jibs often include hydraulic cylinders used to reposition the jib on a chassis of the hooklift truck and control a position of the hook. Such trucks have found considerable success in the refuse industry.

### SUMMARY

The inventor has noticed that while conventional hooklift trucks are generally robust and reliable, various elements thereof are prone to damage and fatigue. For example, hoses that are used to actuate the hydraulic cylinders often bunch up during operation or excessively rub against other elements of the hooklift truck. This leaves the hoses susceptible to damage and failure. Furthermore, the hoses may take up excessive space. In view of this, the inventors sought a means to cure this problem which has resulted in a new and nonobvious hooklift truck design. While the embodiments set forth herein are directed to improving conventional hooklift trucks, the inventive concepts are not limited thereto as the inventive concepts may be used on a wide array of devices across a wide array of industries.

### BRIEF DESCRIPTION OF THE DRAWINGS

Example embodiments are described in detail below with reference to the attached drawing figures, wherein:

FIGS. 1A-1D are various views of a telescoping port tube in accordance with example embodiments;

FIG. 2A-2C are various cross-section views of the telescoping port tube in accordance with example embodiments;

FIG. 3 is a view of a conventional hooklift truck;

FIGS. 4A-4C are views of an improved jib of a hooklift truck in accordance with example embodiments;

FIG. 5 is an additional view of telescoping port tubes connected to a jib of a hooklift truck in accordance with example embodiments;

FIG. 6 is a view of a jib arranged inside a secondary of a hooklift truck in accordance with example embodiments; and

FIG. 7 is a view of an alternative use of telescoping port tubes in accordance with example embodiments.

### DETAILED DESCRIPTION

Example embodiments will now be described more fully with reference to the accompanying drawings. Example embodiments are not intended to limit the disclosure since the disclosure may be embodied in different forms. Rather, example embodiments are provided so that this disclosure will be thorough and complete, and will fully convey the scope of the disclosure to those skilled in the art. In the drawings, the sizes of components may be exaggerated for clarity.

In this application, when a first element is described as being “on” or “connected to” a second element, the first element may be directly on or directly connected to the second element or may be on or connected to an intervening element that may be present between the first element and the second element. When a first element is described as being “directly on” or “directly connected to” a second element, there are no intervening elements. In this application, the term “and/or” includes any and all combinations of one or more of the associated listed items.

In this application, spatially relative terms merely describe one element's relationship to another. The spatially relative terms are intended to encompass different orientations of the structure. For example, if a first element of a structure is described as being “above” a second element, the term “above” is not meant to limit the disclosure since, if the structure is turned over, the first element would be “beneath” the second element. As such, use of the term “above” is intended to encompass the terms “above” and “below”. The structure may be otherwise oriented (rotated 90 degrees or at other orientations) and the spatially relative descriptors used herein interpreted accordingly.

Example embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Example embodiments relate to a telescoping port tube and devices using the same.

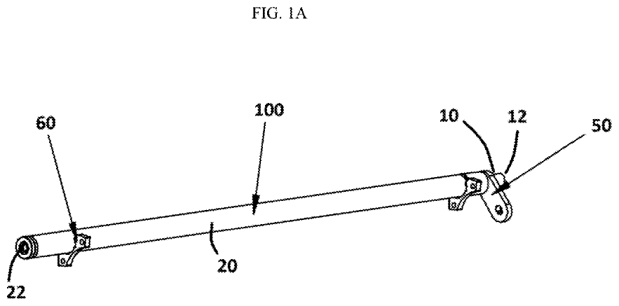

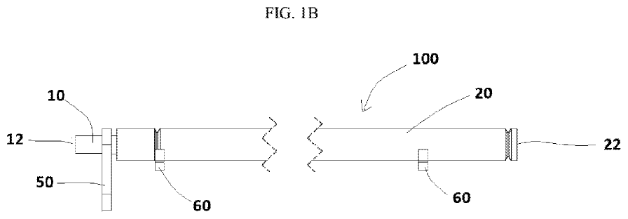

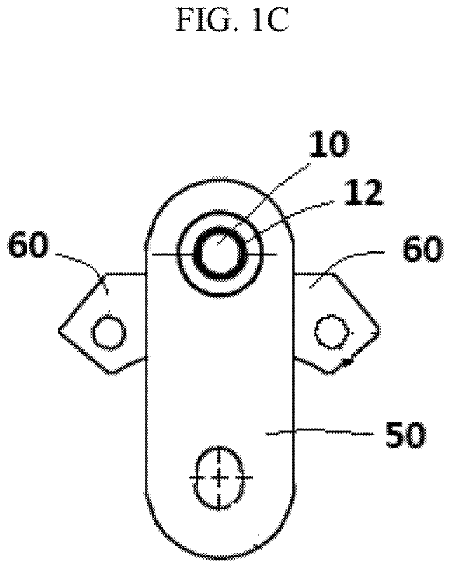

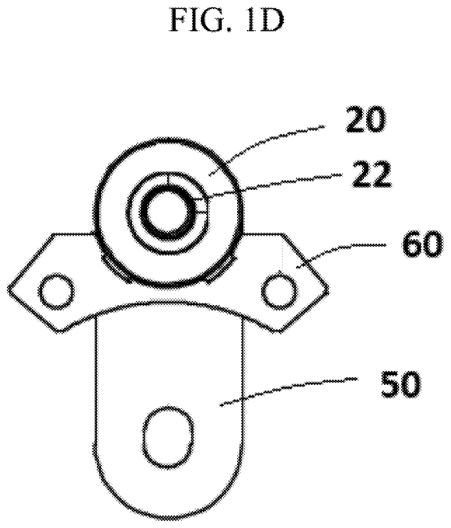

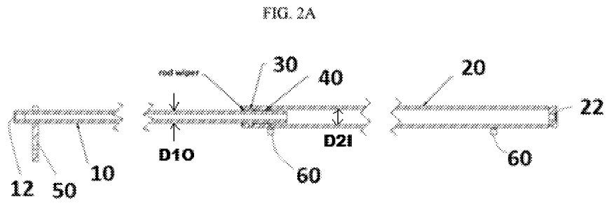

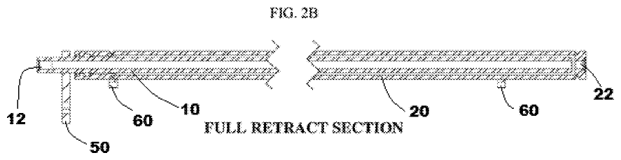

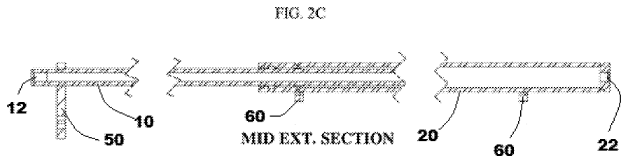

Without intending to limit the invention, FIGS. 1A-1D are views of an exemplary telescoping port tube 100 in accordance with example embodiments. FIGS. 2A-2C show various cross-section views of the exemplary telescoping port tube 100. As shown in FIGS. 1A-1D and 2A-2C the exemplary telescoping port tube 100 generally includes a first cylinder 10 in fluid communication with a second cylinder 20. The first cylinder 10 may have an outer diameter D1O which is slightly smaller than an inner diameter D2I of the second cylinder 20 enabling the first cylinder 10 to slide within the second cylinder 20. FIG. 2A, for example, shows a section view of the first cylinder 10 within the second cylinder 20 where the first cylinder 10 is shown sliding nearly out of the second cylinder 20. Conversely, FIG. 2B shows a section view of the first cylinder 10 largely retracted inside the second cylinder 20. In some embodiments a hydraulic fluid may flow through the first cylinder 10 and the second cylinder 20. To this end, seals 30 may be provided to reduce (if not eliminate) hydraulic fluid leakage between the first cylinder 10 and the second cylinder 20. Further, additional members, for example, a wear ring 40, may be provided to reduce wear between the first cylinder 10 and the second cylinder 20 since these components may slide against one another.

In example embodiments the first cylinder 10 may include a first port 12 enabling a hose or a tube to connect to the first cylinder 10 and the second cylinder 20 may include a second port 22 enabling the second cylinder 20 to connect to a hose or a tube. Thus, fluid (for example, hydraulic fluid) may enter the second cylinder 20 via the second port 22 and flow through the second cylinder 20 and through the first cylinder 10 where it exits the first cylinder 10 through the first port 12. Conversely, fluid may enter the first cylinder 10 through the first port 12 and may flow through the second cylinder 20 and exit the second cylinder 20 via the second port 22. As one skilled in the art will recognize, a length of a fluid flow path through the telescoping port tube 100 may vary depending on how the first cylinder 10 is positioned within the second cylinder 20. For example, the length of the fluid flow path may be relatively long when the telescoping port tube 100 is extended as shown in FIG. 2A or relatively short when the telescoping port tube 100 is retracted as shown in FIG. 2B. Of course, a length of the fluid flow path may be adjusted between these extremes by adjusting a position of the first cylinder 10 within the second cylinder 20 as shown in FIG. 2C.

In example embodiments, the telescoping port tube 100 may be fitted with additional components which may be used to connect the telescoping port tube 100 to another structure, for example, a hydraulic cylinder. For example, the telescoping port tube 100 may include a rod mount 50 attached to the first cylinder 10 to enable a connection of the first cylinder 10 to a rod of the hydraulic cylinder. As another example, the second cylinder 20 may include one or more base mounts 60 enabling the second cylinder 20 to connect to a barrel of the hydraulic cylinder. This allows the telescoping port tube 100 to extend and/or retract as the hydraulic cylinder extends and/or retracts.

It is understood the exemplary embodiment of FIGS. 1A-2C is for the purpose of illustration only and that the invention is not limited thereto. For example, rather than using cylindrical tubes, square or rectangular tubes may be used in lieu of the first cylinder 10 and the second cylinder 20 without departing from the inventive concepts described herein. Similarly, the telescoping port tube 100 may be connected to a structure other than a hydraulic cylinder. For example, the telescoping port tube 100 may be connected to a pneumatic cylinder, or a screw actuator without departing from the inventive concepts described herein. Further yet, while the embodiment of FIGS. 1A-2C illustrate the first cylinder 10 as sliding within the second cylinder 20, example embodiments also allow for the second cylinder 20 to slide within the first cylinder 10. Further, the telescoping port tube 100 may be utilized in a number of inventive ways.

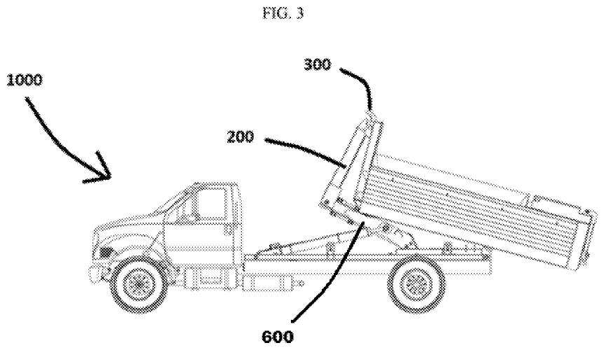

FIG. 3 shows a view of a hooklift truck 1000 commonly used in the refuse industry to grab and haul a refuse container. As shown in FIG. 3, the hooklift truck 1000 includes a jib 200 and a hook 300 telescopingly supported in the jib 200. In many conventional hooklift trucks 1000 the jib 200 includes a first hydraulic cylinder that controls a hook and a second hydraulic cylinder that controls a position of the jib 200 on the hooklift truck 1000. In the conventional art hoses are used to provide hydraulic fluid to the hydraulic cylinders. As one skilled in the art will appreciate, in the conventional art hoses are used to transfer hydraulic fluid to and from a hydraulic cylinder. Pressure from the hydraulic hoses causes the cylinders to either extend or retract. Hoses, however, may be worn and damaged which interferes with their ability to flow hydraulic fluid to and from the first and second hydraulic cylinders. As such, hoses often require replacement. In addition, the hoses may curl taking up space in the jib 200. To resolve these problems, the inventor has incorporated telescoping port tubes 100 to transfer hydraulic fluid to the first hydraulic cylinders used to actuate the hook 300.

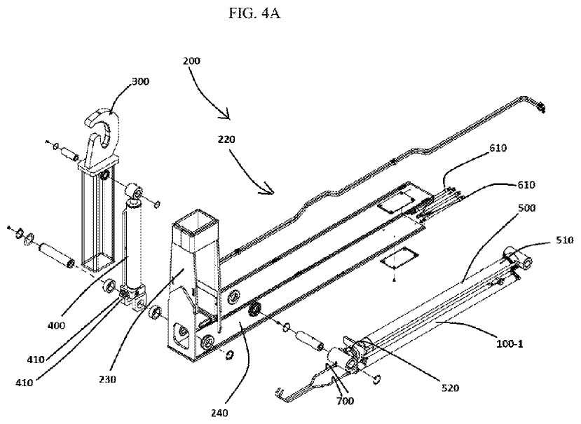

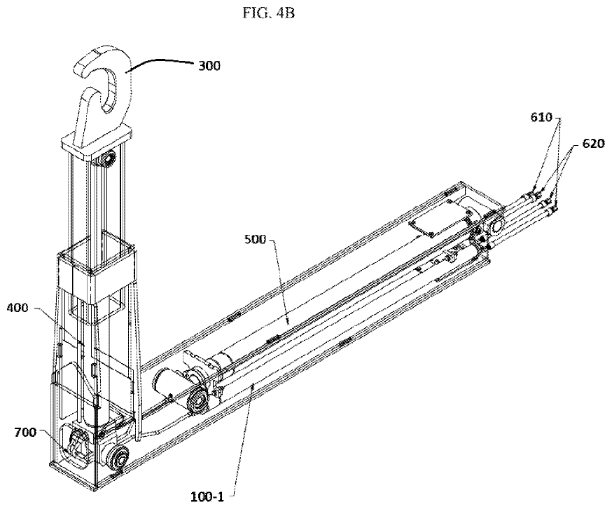

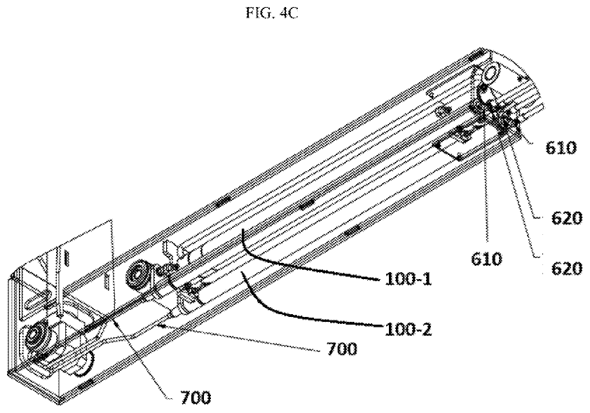

FIG. 4A is an exploded view of a modified jib 200 in accordance with example embodiments. FIG. 4B is a view of the assembled modified jib 200 and FIG. 4C is a second view of the assembled modified jib 200. As is conventional in the art, the jib 200 may have an L-shaped body 220 having a first component 230 and a second component 240. As shown in the figures, the first component 230 and the second component 240 may resemble tubes and may be fabricated from plates to form box-like structures but may also be fabricated from other members such as tube steel. Regardless, the first and second 240 components 230 and 240 allow various items to be arranged inside the first and second components 230 and 240 to facilitate operation of the jib 200. For example, the first component 230 may at least partially enclose a first hydraulic cylinder 400 which may cause the hook 300 to move within the first component 230 of the jib body 220. As yet another example, the second component 240 may at least partially enclose a second hydraulic cylinder 500 which may allow the jib body 220 to move relative to a chassis of the hooklift truck 1000. For example, the second hydraulic cylinder 500 may have a barrel 510 directly or indirectly connected to a chassis of the hooklift truck 1000 and a rod 520 connected to the second component 240. For example, as shown in FIG. 3, the hooklift truck 1000 may include a secondary 600 hollow member which is pin connected to a chassis of the hooklift truck 1000 and the second component 240 may be slidingly supported withing the secondary 600. For example, the barrel 510 of the second hydraulic cylinder 500 may be attached to the secondary 600 while the rod 520 of the second hydraulic cylinder 500 is attached to the second component 240 so that when the second hydraulic cylinder 500 extends or retracts the second component 240 moves within the secondary 600. Thus, in the nonlimiting example embodiment presented herein, the second hydraulic cylinder 500 may cause the jib body 220 to move with respect to a chassis of the hooklift truck 1000 and the first hydraulic cylinder 400 may cause the hook 300 to move relative to the jib body 220.

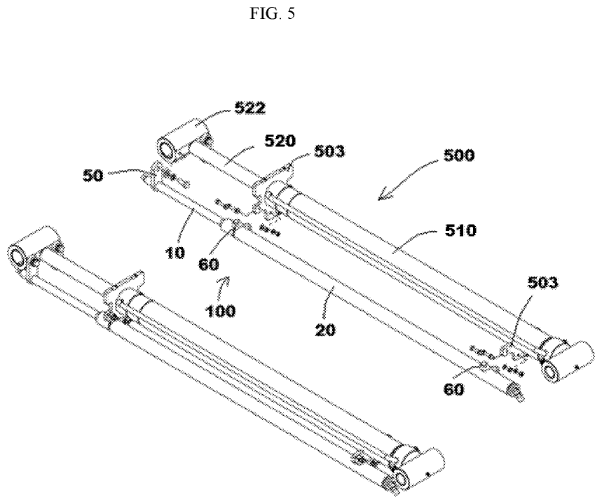

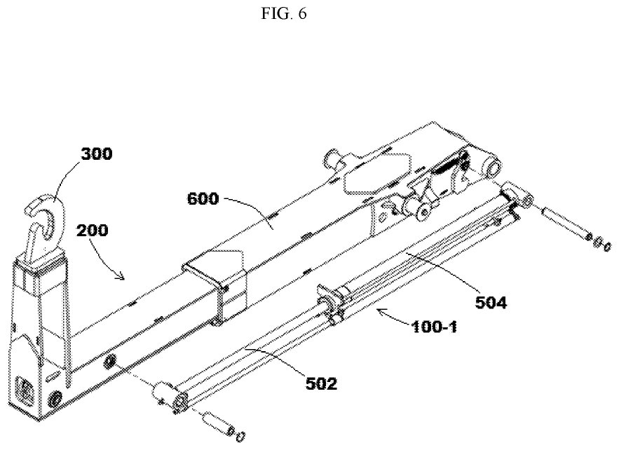

In the nonlimiting example of FIGS. 4A-4C the jib body 220 includes the second hydraulic cylinder 500. The jib body 220 also encloses two telescoping port tubes 100 (shown in the figures as 100-1 and 100-2) arranged on the sides of the second hydraulic cylinder 500. In example embodiments the first cylinders 10 of the telescoping port tubes 100-1 and 100-2 may be connected to the rod 520 of the second hydraulic cylinder 500 by the rod mounts 50 and the second cylinders 20 of the telescoping port tubes 100-1 and 100-2 may be connected to the barrel 510 of the second hydraulic cylinder 500 by the base mounts 60. The rod mounts 50 and the base mounts 60 may be directly connected to the rod 520 and barrel 510 of the hydraulic cylinder 500 or, alternatively, may be detachably attached to the rod 520 and barrel 510 by using conventional fasteners as shown in FIG. 5. In the nonlimiting example of FIG. 5, the barrel 510 includes saddles to which the base mounts 60 may attach via fasteners. In example embodiments the first cylinders 10 may be independently attached to the rod 520 of the second hydraulic cylinder 500 by separate rod mounts 50 or by a single rod mount configured to attach the two first cylinders 10 to the rod 520 of the second hydraulic cylinder 500. For example, two rod mounts 50 may be replaced by a single unitary structure that attaches each of the first cylinders 10 to the rod 520 of the second hydraulic cylinder 500. Similarly, the second cylinders 20 may be attached to the barrel 510 of the second hydraulic cylinder 500 by separate base mounts 60 or a single base mount configured to attach each of the second cylinders 20 to the barrel 510 of the second hydraulic cylinder 500. Regardless, attachment may be made by a conventional means such as, but not limited to, screws, bolts, clips, plates, or welds.

As one skilled in the art would readily appreciate, as the second hydraulic cylinder 500 extends or retracts the two telescoping port tubes 100-1 and 100-2 would also extend and retract. In the embodiment of FIGS. 4A-4C, hydraulic hoses 610 may be attached to the second ports 22 of the two telescoping port tubes 100-1 and 100-2. Also shown in FIGS. 4A-4C are tubes 700 (which, in one embodiment, may be relatively rigid) which connect first ports 12 of the two telescoping port tubes 100-1 and 100-2 to ports 410 of the first hydraulic cylinder 400. Thus, in example embodiments the first hydraulic cylinder 400 may receive and/or discharge hydraulic fluid via the telescoping port tubes 100-1 and 100-2 arranged at the sides of the first hydraulic cylinder 300. As one skilled in the art would readily appreciate, the use of telescoping port tubes 100, rather than hoses, more efficiently uses space in the jib body 220. Additionally, because the geometry of the tubes 700 remains relatively unchanged whether or not either one of, or both of, the first and second hydraulic cylinders 400 and 500 are actuated, fatigue and wear on the tubes are significantly lower than would be incurred if hoses were used instead. Thus, the inventor's inventive concepts improve over the prior art by creating a jib 200 that more efficiently uses space while replacing components vulnerable to wear and tear with components that do not.

FIG. 5 illustrates additional inventive concepts for the purpose of clarity. As shown in FIG. 5, the hydraulic cylinder 500 may include the barrel 510 and the rod 520. The barrel 510 may include saddles 503 which may allow the base mounts 60 to attach to the barrel 510 by fasteners, for example, screws, nuts, bolts, pins, etc. This allows for a telescoping port tube to be removably connected to the barrel 510 of the hydraulic cylinder 500. Further, in example embodiments, the rod 520 may include a boss 522 to which the rod mounts 50 may attach. For example, the boss 522 may include a threaded aperture which may receive threads of a connector to secure the rod mount 50 to the boss 522.

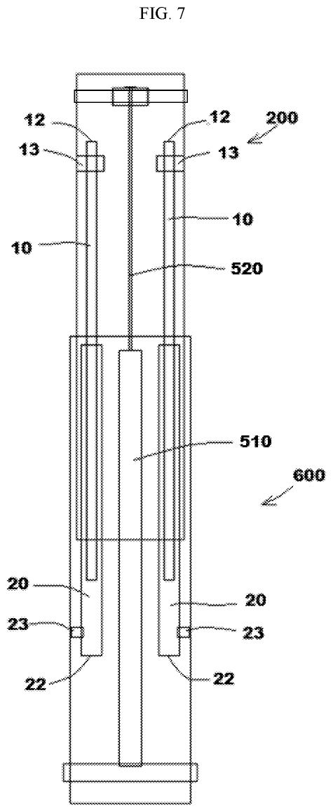

FIG. 7 illustrates an alternative application of telescoping port tubes 100 in accordance with example embodiments. In particular, FIG. 7 illustrates a jib 200 at least partially inserted into a secondary 600. In this nonlimiting example embodiment, rather than connecting the telescoping port tubes 100 to a hydraulic cylinder 500, the telescoping port tubes 100 are connected to, at one end, inside surfaces of the jib 200 and, at another end inside surfaces of the secondary 600 via connectors 13 and 23. In this nonlimiting example embodiment the telescoping port tubes 100 would extend and retract as the cylinder 500 extends and retracts similar to the above embodiments.

What we claim is:

1. An apparatus comprising:
a first hydraulic cylinder;
a first telescoping port tube attached to the first hydraulic cylinder, wherein the first telescoping port tube includes a first cylinder connected to a rod of the first hydraulic cylinder and a second cylinder connected to a barrel of the first hydraulic cylinder; and
a second telescoping port tube attached to the first hydraulic cylinder, wherein the second telescoping port tube includes a third cylinder connected to the rod of the first hydraulic cylinder and a fourth cylinder connected to a barrel of the first hydraulic cylinder.

2. The apparatus of claim 1, wherein the apparatus includes an L-shaped jib having a second hydraulic cylinder configured to actuate a hook supported by the L-shaped jib.

3. The apparatus of claim 2, wherein the first and second telescoping port tubes transfer hydraulic fluid to and from the second hydraulic cylinder.

4. The apparatus of claim 2, the second hydraulic cylinder is a double acting cylinder.

5. The apparatus of claim 2, further comprising:
a secondary pin connected to a chassis of the apparatus, wherein the L-shaped jib is slidingly supported within the secondary.

6. The apparatus of claim 5, wherein one of a barrel and a rod of the first hydraulic cylinder is pin connected to the secondary and the other of the barrel and the rod of the first hydraulic cylinder is connected to the jib so that as the first hydraulic cylinder extends or retracts the jib moves within the secondary.

7. The apparatus of claim 2, further comprising a first tube connected to the first cylinder of the first telescoping port tube and a second tube connected to the third cylinder of the second telescoping port tube, wherein the first and second tubes connect to the second hydraulic cylinder.

8. The apparatus of claim 7, wherein the first and second tubes are relatively rigid.

9. The apparatus of claim 1, further comprising, a third hydraulic cylinder to pivot the first hydraulic cylinder with respect to a chassis of the apparatus.

10. A hooklift truck comprising:
a chassis;
a secondary pivotally supported on the chassis;
a jib assembly slidingly supported in the secondary, wherein the jib assembly includes an L-shaped body, a first hydraulic cylinder having one of a barrel and a rod connected to the secondary and the other of the barrel and the rod connected to the L-shaped body so that as the first hydraulic cylinder extends or retracts the L-shaped body slides within the secondary, a pair of telescoping port tubes having first ends connected to the barrel of the first hydraulic cylinder and second ends connected to the rod of the hydraulic cylinder so that as the first hydraulic cylinder extends or retracts the pair of telescoping port tubes extends or retracts, a second hydraulic cylinder configured to move a hook of the jib assembly, and a pair of tubes connecting the pair of telescoping port tubes to the second hydraulic cylinder.
